(19) United States
(12) Patent Application Publication
(10) Pub. No.: US 2021/0239730 A1
(43) Pub. Date: Aug. 5, 2021

(54) REVERSE DETECTION FOR ROTATING MACHINERY

(71) Applicant: BENTLY NEVADA, LLC, Minden, NV (US)

(72) Inventors: Jian WANG, Shanghai (CN); Jianjun JIANG, Shanghai (CN)

(21) Appl. No.: 17/051,551

(22) PCT Filed: May 2, 2018
(86) PCT No.: PCT/CN2018/085298

§ 371 Date: Oct. 29, 2020

(51) Int. Cl. G01P 13/04

(52) U.S. Cl. CPC G01P 13/04

(57) ABSTRACT

A rotation sensing system and methods for using the same are provided. The system can include a single proximity sensor (114) in communication with a controller (116). The proximity sensor (114) can include including a sensor head (120) having a generally planar sensing face (120f) and a sensing element (122) housed within the sensor head (120). The sensing element (122) can be configured to generate a magnetic field (124) in response to receipt of a driving current. The sensor (114) can be further configured to output a signal (302, 402, 608) in response to a predetermined feature of a target (104) rotating through the generated magnetic field (124) and the signal (302, 402, 608) can include a pulse (306, 406, 612) having first and second pulse portions occurring before and after a non-zero peak amplitude. The controller (116) can be configured to receive the signal (302, 402, 608), detect an asymmetry between the first and second portions of the pulse, and determine a rotation direction of the target based upon the detected asymmetry.

### BACKGROUND

Sensors can be used in a variety of industries to monitor equipment. As an example, sensors can be used to monitor rotating machine components (e.g., shafts, gears, cams, etc.) by outputting signals that can be used to determine rotational speed. The measured rotational speed can be compared to targets to identify anomalous operating conditions, such as overspeed (rotation speed greater than a target maximum speed) and underspeed (rotation speed less than a target minimum speed).

Two or more sensors measuring rotational speed can also be employed to measure rotational direction. It can be beneficial to measure the rotational direction of a rotating machine component because operating a rotating machine component in a rotational direction opposite an intended rotation direction can result in damage to the machine.

### SUMMARY

In general, systems and methods are provided for detection of a rotation direction of a rotating component using sensors such as proximity sensors.

In one embodiment, a sensing system is provided and it can include a sensor and a controller in electrical communication with the sensor. The sensor can include a sensor head and a coil housed within the sensor head. The sensor head can have a generally planar sensing face and the coil can be configured to generate a magnetic field in response to a driving current. The sensor can also be configured to output a signal in response to a predetermined feature of a target rotating through the generated magnetic field. The signal can include a pulse having a first portion occurring prior to a non-zero peak amplitude and a second portion occurring after the non-zero peak amplitude. The controller can be configured to receive the signal, detect an asymmetry between the first portion of the pulse and the second portion of the pulse, and determine a direction of rotation of the target about the rotation axis based upon the detected asymmetry.

The sensing system can include a single sensor or multiple sensors, and the sensor can have a variety of configuration. In one embodiment, the sensor can be a proximity sensor. When the sensing system includes multiple sensors, the controller can be configured to receive the signal output by each sensor and determine a direction of rotation of the target for each signal, independent of the other signals.

In another embodiment, the system can include the target. The sensor can be positioned with respect to the target such that a first normal to the sensing face is oriented at a non-zero angle relative to a second normal to an outer surface of the target that is rotationally offset from the target feature.

In another embodiment, a magnitude of the non-zero angle can be in a range from about 8° to about 16°. In certain exemplary embodiments, a magnitude of the non-zero angle can be about 12°. In further embodiments, the magnitude of the non-zero angle can adopt other values without limit.

In another embodiment, the system can include the target and the target feature can be substantially symmetric about a bisector.

In another embodiment, the controller can be configured to determine a first slope of the first pulse portion and a second slope of the second pulse portion, and to determine the direction of rotation based upon the relative magnitudes of the first and second slopes.

In other aspects, the system can include the target and the target feature can protrude from the outer surface of the target. The controller can be configured to determine the direction of rotation to be a first rotation direction when the magnitude of the first slope is greater than the second slope, and to determine the direction of rotation to be a second rotation direction, opposite the first rotation direction, when the magnitude of the first slope is less than the magnitude of the second slope.

In another embodiment, the system can include the target and the target feature can be recessed from an outer surface of a body of the target. The controller can be configured to determine the direction of rotation to be a first direction when the magnitude of the first slope is less than the second slope, and to determine the direction of rotation to be a second rotation direction, opposite the first rotation direction, when the magnitude of the first slope is greater than the magnitude of the second slope.

Methods for sensing a rotation direction of a rotating target are also provided. In one embodiment, the method can include positioning a sensor with respect to a target having a predetermined target feature. The sensor can have a sensor head including a generally planar sensing face and a first normal of the sensing face can be oriented at a non-zero angle relative to a second normal of an outer surface of the target that is rotationally offset from the target feature. The method can also include generating, by a coil housed within the sensor head, a magnetic field in response to a driving current. The method can additionally include outputting, by the sensor, a signal in response to rotation of the target feature through the generated magnetic field. The signal can include a pulse having a first portion occurring prior to a non-zero peak amplitude and a second portion occurring after the non-zero peak amplitude. The method can further include receiving, by a controller in electrical communication with the sensor, the signal. The method can additionally include detecting, by the controller, an asymmetry between the first portion of the pulse and the second portion of the pulse. The method can also include determining, by the controller, a direction of rotation of the target about the rotation axis based upon the detected asymmetry.

In another embodiment, the magnitude of the non-zero angle can be in a range from about 8° to about 16°. In certain exemplary embodiments, a magnitude of the non-zero angle can be about 12°. In further embodiments, the magnitude of the non-zero angle can adopt other values without limit.

In another embodiment, the target feature can be substantially symmetric about a bisector.

In other aspects, the method can include determining, by the controller, a first slope of the first pulse portion and a second slope of the second pulse portion, and determining, by the controller, the direction of rotation based upon the relative magnitudes of the first and second slopes.

In another embodiment, the method can include, when the target feature protrudes from the outer surface of the target, determining, by the controller, the direction of rotation to be a first rotation direction when the magnitude of the first slope is greater than the second slope, and determining, by the controller, the direction of rotation to be a second rotation direction, opposite the first rotation direction, when the magnitude of the first slope is less than the magnitude of the second slope.

In other aspects, the method can include, when the target feature is recessed from the outer surface of the target, determining, by the controller, the direction of rotation to be a first rotation direction when the magnitude of the first slope is less than the second slope, and determining, by the controller, the direction of rotation to be a second rotation direction, opposite the first rotation direction, when the magnitude of the first slope is greater than the magnitude of the second slope.

### DESCRIPTION OF DRAWINGS

These and other features will be more readily understood from the following detailed description taken in conjunction with the accompanying drawings, in which:

FIG. 1 is a diagram illustrating one exemplary embodiment of an operating environment including a rotation sensing system including a single proximity sensor having a sensor head and a rotating target having a target feature protruding from a target body;

FIG. 2A is a diagram illustrating an exemplary embodiment of an operating environment containing the target and the rotation sensing system of FIG. 1, showing the target rotating in either a first or second direction, where a normal vector of the sensor head is substantially aligned with a normal vector of the target body;

FIG. 2B is a plot of amplitude as a function of time illustrating an exemplary waveform output by the single proximity sensor of FIG. 2A that includes symmetrical pulses;

FIG. 3A is a diagram illustrating an exemplary embodiment of an operating environment containing the target and the rotation sensing system of FIG. 1, showing the target rotating in a first rotation direction and a normal vector of the sensor head is positioned at a non-zero angle relative to a normal vector of the target body;

FIG. 3B is a plot of amplitude as a function of time illustrating an exemplary waveform output by the single proximity sensor of FIG. 3A that includes asymmetrical pulses;

FIG. 4A is a diagram illustrating an exemplary embodiment of an operating environment containing the target and the rotation sensing system of FIG. 1, showing the target rotating in a second rotation direction, opposite the first rotation direction, and a normal vector of the sensor head is positioned at a non-zero angle relative to a normal vector of the target body;

FIG. 4B is a plot of amplitude as a function of time illustrating an exemplary signal waveform output by the single proximity sensor of FIG. 3A that includes asymmetrical pulses;

FIG. 5 is an expanded view of FIG. 3B illustrating an exemplary first asymmetrical pulse;

FIG. 6A is a diagram illustrating an exemplary embodiment of an operating environment containing a target having a notched target feature and the rotation sensing system of FIG. 1, showing the notched target rotating in a first rotation direction, where a normal vector to the sensor head is positioned at a non-zero angle with relative to a normal vector of the target body;

FIG. 6B is a plot of amplitude as a function of time illustrating an exemplary waveform output by the single proximity sensor of FIG. 6A that includes asymmetrical pulses;

FIG. 7A is a diagram illustrating an exemplary embodiment of an operating environment containing the notched target of FIG. 6A and the rotation sensing system of FIG. 1, showing the notched target rotating in a second rotation direction, opposite the first rotation direction, and a normal vector of the sensor head is positioned at a non-zero angle relative to a normal vector of the target body;

FIG. 7B is a plot of amplitude as a function of time illustrating an exemplary waveform output by the single proximity sensor of FIG. 7A that includes asymmetrical pulses; and

FIG. 8 is a flow diagram illustrating an exemplary embodiment of a method for measuring a rotation direction of a target that employs a single proximity sensor.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Sensors can be used in a variety of industries to monitor equipment. As an example, it can be beneficial to measure a rotation direction of a rotating machine component because the machine can be damaged if the component rotates in a direction opposite to an intended rotation direction. In one aspect, a rotating machine component can be a rotor of a turbomachine, such as a gas turbine employed for power generation. In another aspect, a rotating machine component can be a gear, such as a gear of a power transmission system. Proximity sensors can be used to measure rotating speed, however, to measure the rotation direction of a rotating machine component, two or more proximity sensors can be used in combination. In general, each proximity sensor can generate a magnetic field and when a target feature (e.g., a tooth of a gear) passes through its magnetic field, electrical signals including pulses, are produced. When a first sensor transmits a signal prior to a second sensor, it can be used to determine a direction of rotation.

However, the need to use two or more proximity sensors to determine the rotation direction can increase the cost and complexity of monitoring. Accordingly, improved rotation direction measurements are provided that allow a single proximity sensor to accurately determine a rotation direction of a rotating machine component. The rotation direction measurements can be acquired by the single proximity sensor positioned at an angle to the target. In this orientation, the strength of the magnetic field through which the target feature passes is different when the target feature rotates towards the proximity sensor, as compared to when the target feature rotates away from the proximity sensor. As a result, the shape of the pulses produced by the proximity sensor are different when the target feature rotates towards the proximity sensor, as compared to when the target feature rotates away from the proximity sensor, referred to as an asymmetry. By detecting asymmetries in the pulses, the target rotation direction can be determined.

Embodiments of sensing systems and corresponding methods for measuring the rotation direction of rotating machine components using proximity sensors are discussed herein. However, embodiments of the disclosure can be employed with other sensors that generate magnetic fields without limit.

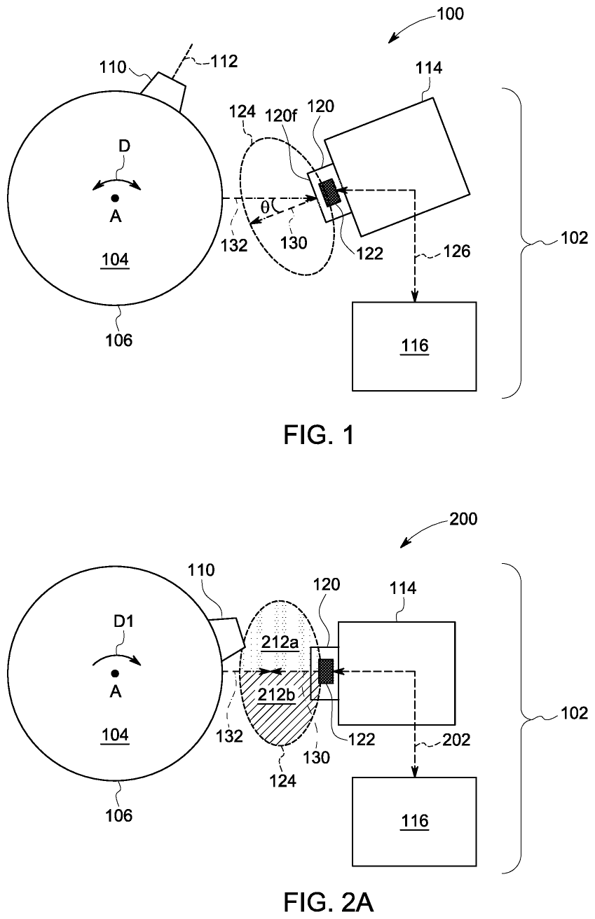

FIG. 1 illustrates one exemplary embodiment of an operating environment 100 containing a rotation sensing system 102 and a target 104. The target 104 can include a target body 106 and a target feature 110. The target body 106 can be configured to rotate about a target axis A in a rotation direction D (e.g., clockwise or counter-clockwise). In certain embodiments, the target feature 110 can be approximately symmetric about a bisector 112. As shown, the target feature 110 protrudes from an outer surface of the target body 106. However, in alternative embodiments, the target feature can be recessed from the outer surface of the target body.

The rotation sensing system 102 can include a proximity sensor 114 in communication with a controller 116. The proximity sensor 114 can include a sensor head 120 that houses a sensing element 122. The sensor head 120 can include a generally planar sensing face 120f (e.g., a surface facing the target 104). The sensing element 122 can be configured to generate a magnetic field 124 in response to receipt of a driving current. The proximity sensor 114 can also be configured to output signal waveforms, referred to herein as signals 126, having an amplitude related to a change in a distance between the target 104 and the sensing element 122. The rotation sensing system 102 can also be in communication with a power source (not shown), such as electrical outlets, electrical generators, batteries, etc., for supplying electrical power to the proximity sensor 114 and the controller 116.

In use, the proximity sensor 114 can be positioned proximate to the target 104. In one aspect, the sensor head 120 can be positioned such that the target feature 110 rotates through the magnetic field 124. In another aspect, the proximity sensor 114 can be positioned at a predetermined angle θ with respect to the target 104. The angle θ can be an angle defined between a normal vector of the sensor head 120, referred to herein as sensor normal 130, and a normal vector of the target body 106, referred to herein as target normal 132. In certain embodiments, the magnitude of the angle θ can be in a range from about 8° to about 16°. In certain exemplary embodiments, the magnitude of the angle θ can be about 12°. In further embodiments, the magnitude of the non-zero angle can adopt other values without limit. So positioned, the signals 126 output by the sensing element 122 can include pulses that rise in amplitude as the target feature 110 moves closer to the sensing element 122 within the magnetic field 124, and that fall in amplitude as the target feature 110 moves away from the sensing element 122 within the magnetic field 124.

As discussed in greater detail below, when the angle θ is not zero, the pulses within the signals 126 can be asymmetric about their peak. The controller 116 can be configured to receive the signals 126 and detect this asymmetry. The controller 116 can also be configured to detect the rotation direction of the target 104 about the rotation axis A based upon the detected asymmetry. In this manner, the rotation direction of the target 104 can be determined using proximity measurements from a single proximity sensor 114, in contrast to existing approaches that require at least two proximity sensors.

In certain embodiments, the proximity sensor 114 can be coupled to a frame or other stationary fixture (not shown). The frame can be configured to support the proximity sensor 114 for positioning the sensor head 120 at a desired position and angle θ with respect to the target 104.

The target 104 can be a component of any machine or equipment that is configured to rotate. Examples of rotating components include, but are not limited to, gears, shafts, rotors, belts, etc. Examples of machines and equipment incorporating rotating components include, but are not limited to, turbomachines (e.g., turbine engines, compressors, pumps, and combinations thereof), generators, combustion engines, and combinations thereof. A load (e.g., a torque) can be applied to the target 104 by a driver (e.g., a reciprocating engine, a combustion engine, a turbine engine, an electrical motor, etc.) to cause the target 104 to rotate about the axis A. The target 104 can be formed from materials including, but not limited to, ferromagnetic materials such as iron, steel, nickel, cobalt, and alloys thereof. In some embodiments, the target can be non-magnetized. In other embodiments, the target can be magnetized.

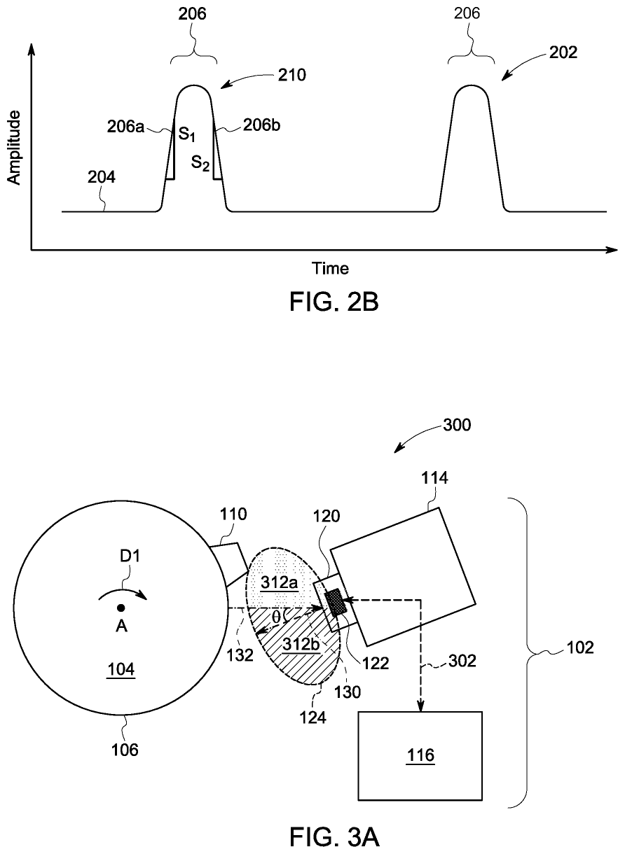

FIG. 2A illustrates one exemplary embodiment of an operating environment 200 containing the target 104 and the rotation sensing system 102. As shown, the angle θ between the sensor normal 130 and the target normal 132 is approximately zero and the target 104 rotates in a rotation direction D1 (e.g., clockwise). During rotation of the target 104, the target feature 110 can interact with the magnetic field 124. In general, the target 104 can perturb the magnetic field 124 (e.g., cause the magnetic field 124 to increase or decrease) when the target feature 110 is sufficiently close to the sensing element 122. In turn, the proximity sensor 114 can output the signal 126 (e.g., voltage as a function of time) with an amplitude that is approximately proportional to the distance between the sensing element 122 and the target feature 110.

As discussed above, the sensing element 122 can be configured to generate the magnetic field 124 in response to receipt of a driving current (e.g., an AC current). The controller 116 can be configured to control characteristics (e.g., frequency, amplitude, etc.) of the driving current. For clarity, the magnetic field 124 is represented by a single line in FIG. 2A. However, it can be understood that the magnetic field 124 is a vector field having a magnitude and direction at each point in space. For a constant driving current, the strength of the magnetic field 124 can decrease with increasing distance from the sensing element 122.

The controller 116 can be any computing device employing a general purpose or application-specific processor. In either case, the controller 116 can include a memory and a processor (not shown). The memory can be configured to store instructions related to characteristics of the driving current, such as frequency, amplitude, and combinations thereof. The memory can also store instructions and algorithms for detecting an asymmetry within pulses of the signal 126. In certain embodiments, the memory can also store instructions and algorithms for determining a direction of rotation of the target 104 about the rotation axis A based upon the detected asymmetry. The processor can include one or more processing devices, and the memory can include one or more tangible, non-transitory, machine-readable media collectively storing instructions executable by the processor to perform embodiments of the methods described herein. Embodiments of the controller 116 can be implemented using analog electronic circuitry, digital electronic circuitry, and/or combinations thereof.

An exemplary signal 126 in the form of signal 202, corresponding to the operating environment 200 of FIG. 2A, is illustrated in FIG. 2B. The plot of FIG. 2B, and other signal plots discussed herein, are based upon a negative coordinate system, where the ordinate (y-axis coordinate representing magnitude) becomes less negative with increasing distance from the horizontal or x-axis representing time. However, it can be appreciated that the analytical results discussed below are substantially similar when using a positive coordinate system representation as well. That is, the ordinate is approximately symmetric about the time axis.

As shown, the signal 202 includes a baseline 204 and pulses 206 at periodic intervals. Each pulse 206 can include a first portion 206a that rises from the baseline 204 to a peak 210 and a second portion 206b that falls from the peak 210 to the baseline 204. The baseline 204 can represent the portion of the target rotation where perturbation of the magnetic field 124 by the target feature 110 is substantially negligible because the distance between the target feature 110 and the sensing element 122 is relatively large. Thus, the amplitude of the signal 202 can be relatively small and approximately constant within the baseline 204. The first portion 206a of the pulse 206 can represent the portion of the target rotation where the distance between the target feature 110 and the sensing element 122 decreases and perturbation of the magnetic field 124 by the target feature 110 is significant. The second portion 206b of the pulse 206 can represent the portion of the target rotation where the distance between the target feature 110 and the sensing element 122 is increasing and perturbation of the magnetic field 124 by the target feature 110 remains significant.

As further illustrated in FIG. 2B, the first portion 206a of the pulse 206 can be characterized by a slope S₁ and the second portion 206b of the pulse 206 can be characterized by a slope S₂. When the angle θ between the sensor normal 130 and the target normal 132 is approximately zero, as schematically illustrated in the operating environment 200 of FIG. 2A, the slopes S₁ and S₂ of the pulse 206 illustrated in FIG. 2B can be approximately the same. That is, each pulse 206 can be approximately symmetric about the peak 210. This symmetry can arise because the strength of a first portion 212a of the magnetic field 124 through which the target feature 110 passes when rotating towards the sensing element 122 is approximately the same as the strength of a second portion 212b of the magnetic field 124 through which the target feature 110 passes when rotating away from the sensing element 122. While not illustrated, when the rotation direction D1 is reversed, the same result can also occur when the angle θ between the sensor normal 130 and the target normal 132 is approximately zero.

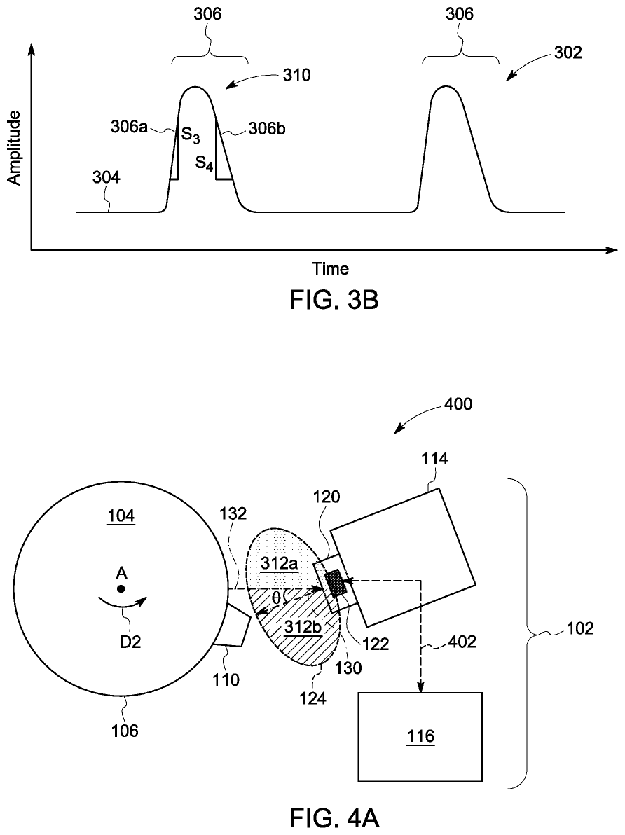

FIG. 3A illustrates another exemplary embodiment of an operating environment 300 containing the target 104 and the rotation sensing system 102 of FIG. 1. Operating environment 300 can be similar to the operating environment 200 of FIG. 2A, except that the angle θ between the sensor normal 130 and the target normal 132 is a non-zero angle. During rotation of the target 104, the target feature 110 can interact with the magnetic field 124 and the proximity sensor 114 can output the signal 126.

An exemplary signal 126 in the form of signal 302, corresponding to operating environment 300, is illustrated in FIG. 3B. As shown, the signal 302 includes a baseline 304 with pulses 306 at periodic intervals. Each pulse 306 of the signal 302 can include a first portion 306a that rises from the baseline 304 to a peak 310 and a second portion 306b that falls from the peak 310 to the baseline 304. As discussed above, the baseline 304 can represent the portion of the target rotation where perturbation of the magnetic field 124 by the target feature 110 is substantially negligible, while the first portion 306a and second portion 306b of the pulse 306 can represent the portions of the target rotation where perturbation of the magnetic field 124 by the target feature 110 remains significant and the distance between the target feature 110 and the sensing element 122 is decreasing (first portion 306a) or increasing (second portion 306b).

As further illustrated in FIG. 3B, the first portion 306a of the pulse 306 can be characterized by a slope S₃ and the second portion 306b of the pulse 306 can be characterized by a slope S₄, where the slopes S₃ and S₄ are different. That is, each pulse 306 can be substantially asymmetric about the peak 310, with the slope S₃ being greater than the slope S₄.

This asymmetry can arise due to orientation of the proximity sensor 114 at the non-zero angle θ and clockwise rotation the target 104, as illustrated in FIG. 3A. The strength of a first 312a portion of the magnetic field 124 through which the target feature 110 passes when rotating towards the sensing element 122 is greater than the strength of a second portion 312b of the magnetic field 124 through which the target feature 110 passes when rotating away from the sensing element 122. As a result, the signal amplitude increases at a faster rate when the target feature 110 rotates towards the sensing element 122 as compared to when the target feature 110 rotates away from the sensing element 122, manifesting in the slope S₃ being greater than the slope S₄.

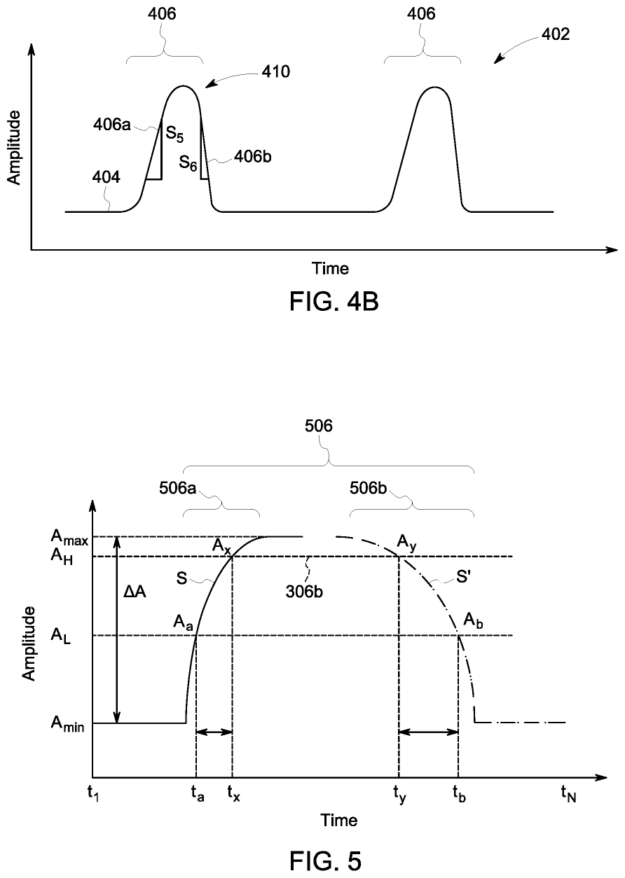

The opposite result can occur when the rotation direction is reversed from direction D1 to direction D2 (e.g., counter-clockwise) while keeping the non-zero angle θ constant, as illustrated in the operating environment 400 of FIG. 4A An exemplary signal 126 in the form of signal 402, corresponding to operating environment 400, is illustrated in FIG. 4B. As shown, the signal 402 includes a baseline 404 with pulses 406 at periodic intervals including a first portion 406a having a slope S₅ and a second portion 406b having a slope S₆. Each pulse 406 can be substantially asymmetric about a peak 410, with the slope S₅ less than the slope S₆.

In contrast to operating environment 300, in operating environment 400, the strength of the second portion 312b of the magnetic field 124 through which the target feature 110 passes when rotating towards the sensing element 122 is less than the strength of the first portion 312a of the magnetic field 124 through which the target feature 110 passes when rotating away from the sensing element 122. As a result, the signal amplitude increases at slower rate when the target feature 110 rotates towards the sensing element 122 as compared to when the target feature 110 rotates away from the sensing element 122, manifesting in slope S₅ being less than slope S₆.

The signal 126 (e.g., 302, 402) can be communicated by wired or wireless connections to the controller 116. The proximity sensor 114 can include electronic components (e.g., amplifiers, filters, etc.) that can condition the signal 126 before transmission to the controller 116. In other embodiments, the signal 126 can be conditioned after being processed by the controller 116. In further embodiments, the signal can be communicated to a memory and stored for later retrieval by the controller.

Upon receipt of the signal 126 (e.g., 302, 402), the controller 116 can be configured to detect an asymmetry between the first portion and second portion of pulses contained within the signal 126. FIG. 5 illustrates a pulse 506 including a first portion 506a having a slope S and a second portion 506b having a slope S′. The pulse 506 is an expanded view of the pulse 306 of FIG. 3B and exhibits an asymmetry where slope S is greater than slope S′.

The controller 116 can determine the slopes S and S′ of the first portion 506a and the second portion 506b of the pulse 506. As discussed below, in certain embodiments, only a part of the first portion 506a and the second portion 506b are used to determine the slopes S and S′. However, it can be understood that, in alternative embodiments, substantially all of the first and second portions of the pulse can be used to determine the slopes S and S′.

As an example, the slopes S and S′ can be characterized over a predetermined amplitude range. For clarity of the discussion, take Aₘₐₓ to be the maximum amplitude of the pulse 506, Aₘᵢₙ to be the maximum amplitude of the pulse 506, ΔA to be an amplitude difference between the maximum amplitude Aₘₐₓ and the minimum amplitude Aₘᵢₙ, and A_{L} and A_{H} to be amplitudes intermediate to maximum amplitude Aₘₐₓ and minimum amplitude Aₘᵢₙ. In certain embodiments, amplitude A_{L} can be a first predetermined fraction of the amplitude difference ΔA (e.g., about ½ of ΔA) and the amplitude A_{H} can be a second predetermined fraction of the difference ΔA (e.g., about ⅞ of ΔA). It can be understood that the first and second predetermined fractions can adopt other values without limit.

The amplitude range defined by amplitudes A_{L} and A_{H} can be used to characterize the slopes S and S′. A first point on the pulse 506 can be defined at amplitude A_{L} within the first portion 506a (e.g., Aₐ, tₐ) and a second point on the pulse 506 can be defined at amplitude A_{L} within the second portion 506b (e.g., A_{b}, t_{b}). Similarly, a third point on the pulse 506 can be defined at amplitude A_{H} within the first portion 506a (e.g., Aₓ, tₓ) and a fourth point on the pulse 506 can be defined at amplitude A_{H} within the second portion 506b (e.g., A_{y}, t_{y}). Accordingly, the slopes S and S′ can be given by:

$$S = \frac{\vert {A}_{x} - {A}_{a} \vert}{\vert {t}_{x} - {t}_{a} \vert}$$

$${S}^{′} = \frac{\vert {A}_{y} - {A}_{b} \vert}{\vert {t}_{y} - {t}_{b} \vert}$$

Characterizing the slopes S and S′ using the portion of the pulse 506 defined by amplitudes A_{L} and A_{H} can enhance the accuracy of S and S′. As shown in FIG. 5, near the minimum and maximum amplitudes Aₘᵢₙ and Aₘₐₓ, the pulse 506 can exhibit a non-linear shape. Thus using these non-linear portions of the pulse 506 to characterize the slopes S and S′ can introduce error. In contrast, by characterizing the slopes S and S′ in the linear portion of the pulse 506, using the first, second, third, and fourth points, this error can be avoided.

The controller 116 can also compare the slope S to the slope S′ to determine the rotation direction D. As discussed above, in the operating environments 300 and 400, when slope S is greater than slope S′ the target 104 rotates in the rotation direction D1 (e.g., clockwise), and when slope S is less than slope S′ the target 104 rotates in the opposite rotation direction D2 (e.g., counterclockwise). Thus, upon comparing slope S to slope S′, the controller 116 can determine that the target 104 rotates in rotation direction D1 when the magnitude of slope S is greater than the magnitude of slope S′ and it can determine that the target 104 rotates in rotation direction D2 when the magnitude of slope S is less than the magnitude of slope S′. Subsequently, the controller 116 can output this result to a memory and/or provide a notification of this result (e.g., an audio and/or visual notification).

It can also be observed from FIG. 5 that the quantities (Aₓ−Aₐ) and (A_{y}−A_{b}) are equal. Thus, the condition where slope S is greater than slope S′ is equivalent to |t_{b}−t_{y}| being greater than |tₓ−tₐ| Similarly, the condition where slope S is less than slope S′ is equivalent to |tₓ−tₐ| being greater than |t_{b}−t_{y}|. Thus, in alternative embodiments, the controller 116 can be configured to compare the magnitude of the rising time of the first portion 506a, fit, |tₓ−tₐ| to the magnitude of the falling time of the second portion 506b, |t_{b}−t_{y}| to determine whether the target 104 rotates in rotation direction D1 or rotation direction D2.

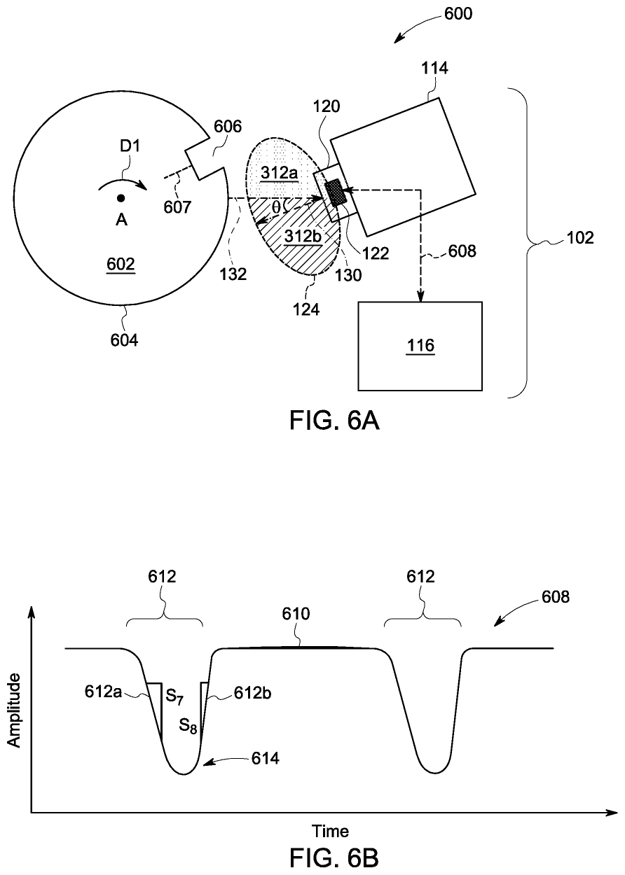

FIG. 6A illustrates one exemplary embodiment of an operating environment 600 containing a target 602 and the rotation sensing system 102. The operating environment 600 can be similar to operating environment 300 of FIG. 3A and the target 602 can be similar to target 104 except that target 104 is replaced by target 602 that includes a target body 604 having a target feature 606 (e.g., a notch) that is recessed from an outer surface of the target body 604. In certain embodiments, the target feature 606 can be approximately symmetric about a bisector 607.

During rotation of the target 602, the target feature 606 can interact with the magnetic field 124 and the proximity sensor 114 can output the signal 126. As discussed below, this interaction reflects that the target feature 606 defines a void or absence of material. Thus, asymmetries in the signal 126 are different than those discussed in the context of operating environments 300, 400.

An exemplary signal 126 in the form of signal 608, corresponding to the operating environment 600, is illustrated in FIG. 6B. As shown, the signal 608 includes a baseline 610 with pulses 612 at periodic intervals. Each pulse 612 of the signal 608 can include a first portion 612a that falls from the baseline 610 to a trough 614 and a second portion 612b that rises from the trough 614 to the baseline 610. As discussed above, the baseline 610 can represent the portion of the target rotation where perturbation of the magnetic field 124 by the target feature 606 is substantially negligible, while the first portion 612a and second portion 612b of the pulse 612 can represent the portion of the target rotation where perturbation of the magnetic field 124 by the target feature 606 remains significant and the distance between the target feature 606 and the sensing element 122 is increasing (first portion 612a) or decreasing (second portion 612b).

As further illustrated in FIG. 6B, the first portion 612a of the pulse 612 can be characterized by a slope S₇ and the second portion 612b of the pulse 612 can be characterized by a slope Sg, where the slopes S₇ and S₈ are different. That is, each pulse 612 can be substantially asymmetric about the trough 614, with the slope S₇ less than the slope Sg.

This asymmetry can arise due to orientation of the proximity sensor 114 at the non-zero angle θ and rotation of the target 602 clockwise, as illustrated in FIG. 6A. The strength of a first portion 312a of the magnetic field 124 through which the target feature 606 passes when rotating towards the sensing element 122 is greater than the strength of a second portion 312b of the magnetic field 312b through which the target feature 606 passes when rotating away from the sensing element 122. As a result, the signal amplitude decreases at a slower rate when the target feature 606 rotates towards the sensing element 122, as compared to when the target feature 606 rotates away from the sensing element 122, manifesting in slope S₇ being less than slope Sg.

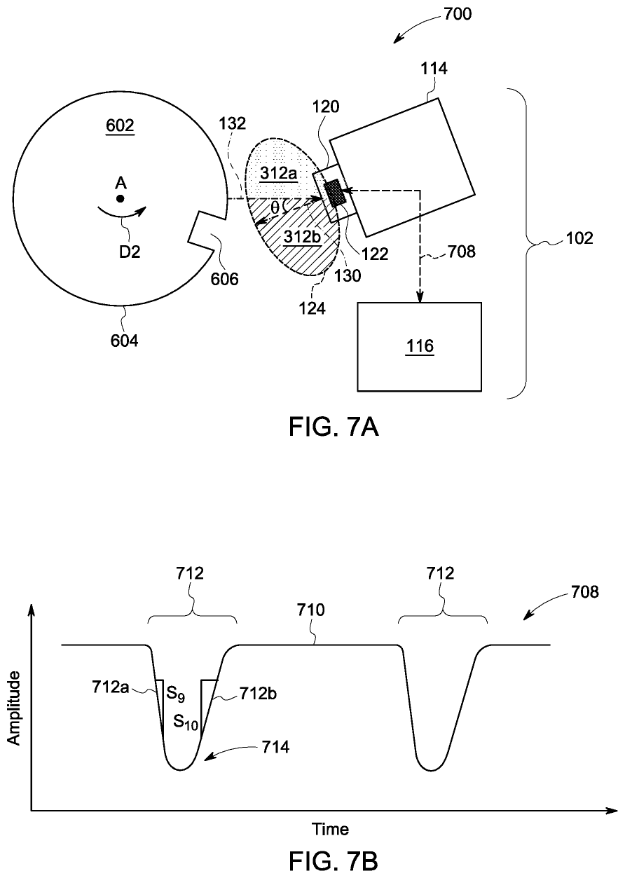

When the rotation direction is reversed from direction D1 to direction D2 (e.g., counter-clockwise) while keeping the non-zero angle θ constant, as illustrated in the operating environment 700 of FIG. 7A, the opposite result can occur. An exemplary signal 126 in the form of signal 708, corresponding to operating environment 700, is illustrated in FIG. 7B. As shown, the signal 708 includes a baseline 710 with pulses 712 at periodic intervals including a first portion 712a having a slope S₉ and a second portion 712b having a slope S₁₀. Each pulse 712 can be substantially asymmetric about a trough 714, with slope S₉ being greater than slope S₁₀.

The controller 116 can be configured to receive the signal 126 (e.g., 608, 708) and detect an asymmetry between the first portion and second portion of pulses contained within the signal 126 by comparing a first slope of the first portion to a second slope of the second portion of the pulses, as discussed above. However, owing to the differences in the interaction of the target feature 606 with the magnetic field 124, as compared to the interaction of target feature 110 with magnetic field 124, the controller 116 can employ different criteria for determining the rotation direction D based upon the slopes of the first portion and the second portion of the pulses. As an example, the controller 116 can determine that the target 602 rotates in rotation direction D1 when the magnitude of the first slope is less than the magnitude of second slope and can determine that the target 602 rotates in rotation direction D2 when the magnitude of the first slope is greater than the magnitude of the second slope. Subsequently, the controller 116 can output this result to a memory and/or provide a notification of this result (e.g., an audio and/or visual notification).

As further discussed above, in alternative embodiments, the controller can be configured to compare the magnitude of the falling time of the first portion of the pulse to the magnitude of the rising time of the second portion to determine whether the target rotates in the rotation direction D1 or rotation direction D2.

In contrast to operating environment 600, in operating environment 700, the strength of the second portion of the magnetic field 312b through which the target feature 606 passes when rotating towards the sensing element 122 is less than the strength of the first portion of the magnetic field 312a through which the target feature 606 passes when rotating away from the sensing element 122. As a result, the signal amplitude decreases at faster rate when the target feature 606 rotates towards the sensing element 122 as compared to when the target feature 606 rotates away from the sensing element 122, manifesting in slope S₉ being greater than slope S₁₀.

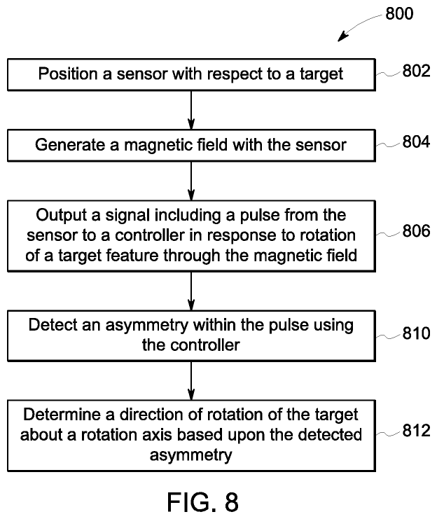

FIG. 8 is a flow diagram illustrating an exemplary embodiment of a method 800 for determining a rotation direction of a rotating object employing a single proximity sensor. In certain aspects, embodiments of the method 800 can include greater or fewer operations than illustrated in FIG. 8 and can be performed in a different order than illustrated in FIG. 8.

In operation 802, a sensor (e.g., proximity sensor 114) can be positioned with respect to a target (e.g., target 104, 602). The sensor can include a sensor head (e.g., 120) having a generally planar sensing face (e.g., 120f). The target can have a predetermined target feature (e.g., 110, 606). As an example, a first normal of the sensing face can be oriented at a non-zero angle relative to a second normal of an outer surface of the target that is substantially rotationally offset from the target feature.

In operation 804, a magnetic field (e.g., 124) can be generated by the sensor. As an example, a sensing element, such as a coil (e.g., 122) mounted within the sensor head, can generate the magnetic field in response to receiving a driving current.

In operation 806, the sensor can output a signal in response to rotation of the target feature through the generated magnetic field. In one embodiment, the signal can include a first portion occurring prior to a non-zero peak amplitude and a second portion occurring after the peak amplitude. The signal can be received by a controller (e.g., 116) in electrical communication with the sensor.

In operation 810, the controller can detect an asymmetry within at least one pulse of the signal using the controller. As an example, the controller can determine a slope of the first and second portions of the pulse.

In operation 812, the controller can determine the direction of rotation of the target based upon the detected asymmetry. As an example, the controller can compare the slopes of the first and second portions of the pulse. Depending upon the structure of the target feature, which can be protruding from the outer surface of the target (e.g., target feature 110) or recessed from the outer surface of the target (e.g., target feature 606), the relative magnitude slopes of the first and second portions of the pulse can be employed to determine the target rotation direction. In further embodiments, relative magnitude of the rising and falling times of the first and second portions of the pulse can be employed to determine the target rotation direction.

Exemplary technical effects of the methods, systems, and devices described herein include, by way of non-limiting example, determination of a rotation direction of a rotating target using a single proximity sensor. The ability to determine rotation direction using a single proximity sensor can decrease the cost and complexity of rotation monitoring.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A sensing system, comprising:
a sensor including a sensor head having a generally planar sensing face, and a coil housed within the sensor head, the coil being configured to generate a magnetic field in response to a driving current, and the sensor being configured to output a signal in response to a predetermined feature of a target rotating through the generated magnetic field, the signal including a pulse having a first portion occurring prior to a non-zero peak amplitude and a second portion occurring after the non-zero peak amplitude; and
a controller in electrical communication with the sensor, the controller configured to receive the signal, to detect an asymmetry between the first portion of the pulse and the second portion of the pulse, and to determine a direction of rotation of the target about the rotation axis based upon the detected asymmetry.

2. The sensing system of claim 1, wherein the sensor comprises a single sensor.

3. The sensing system of claim 1, wherein the sensor is a proximity sensor.

4. The sensing system of claim 1, further comprising the target, wherein the sensor is positioned with respect to the target such that a first normal to the sensing face is oriented at a non-zero angle relative to a second normal to an outer surface of the target that is rotationally offset from the target feature.

5. The sensing system of claim 4, wherein a magnitude of the non-zero angle is from about 8° to about 16°.

6. The sensing system of claim 4, wherein a magnitude of the non-zero angle is about 12°.

7. The sensing system of claim 1, further comprising the target, wherein the target feature is substantially symmetric about a bisector.

8. The sensing system of claim 1, wherein the controller is further configured to determine a first slope of the first pulse portion and a second slope of the second pulse portion, and determine the direction of rotation based upon the relative magnitudes of the first and second slopes.

9. The sensing system of claim 8, further comprising the target, wherein the target feature protrudes from the outer surface of the target, and wherein the controller is configured to determine the direction of rotation to be a first rotation direction when the magnitude of the first slope is greater than the second slope, and to determine the direction of rotation to be a second rotation direction, opposite the first rotation direction, when the magnitude of the first slope is less than the magnitude of the second slope.

10. The sensing system of claim 8, wherein the target feature is recessed from an outer surface of a body of the target, and wherein the controller is further configured to determine the direction of rotation to be a first direction when the magnitude of the first slope is less than the second slope, and determine the direction of rotation to be a second rotation direction, opposite the first rotation direction, when the magnitude of the first slope is greater than the magnitude of the second slope.

11. A sensing method, comprising:
positioning a sensor having a sensor head including a generally planar sensing face with respect to a target having a predetermined feature, wherein a first normal of the sensing face is oriented at a non-zero angle relative to a second normal of an outer surface of the target that is rotationally offset from the target feature;
generating, by a coil housed within the sensor head, a magnetic field in response to a driving current;
outputting, by the sensor, a signal in response to rotation of the target feature through the generated magnetic field, wherein the signal includes a pulse having a first portion occurring prior to a non-zero peak amplitude and a second portion occurring after the non-zero peak amplitude;
receiving, by a controller in electrical communication with the sensor, the signal;
detecting, by the controller, an asymmetry between the first portion of the pulse the second portion of the pulse; and
determining, by the controller, a direction of rotation of the target about the rotation axis based upon the detected asymmetry.

12. The method of claim 11, wherein the magnitude of the non-zero angle is selected from the range from about 8° to about 16°.

13. The method of claim 11, wherein a magnitude of the non-zero angle is about 12°.

14. The method of claim 11, wherein the target feature is substantially symmetric about a bisector.

15. The method of claim 11, further comprising determining, by the controller, a first slope of the first pulse portion and a second slope of the second pulse portion, and determining, by the controller, the direction of rotation based upon the relative magnitudes of the first and second slopes.

16. The method of claim 15, further comprising:
determining, by the controller, the direction of rotation to be a first rotation direction when the magnitude of the first slope is greater than the second slope, and
determining, by the controller, the direction of rotation to be a second rotation direction, opposite the first rotation direction, when the magnitude of the first slope is less than the magnitude of the second slope;
wherein the target feature protrudes from the outer surface of the target.

17. The method of claim 15, further comprising:
determining, by the controller, the direction of rotation to be a first rotation direction when the magnitude of the first slope is less than the second slope; and determining, by the controller, the direction of rotation to be a second rotation direction, opposite the first rotation direction, when the magnitude of the first slope is greater than the magnitude of the second slope;
wherein the target feature is recessed from the outer surface of the target.
